(19) United States
(12) Patent Application Publication
(10) Pub. No.: US 2013/0144664 A1
(43) Pub. Date: Jun. 6, 2013

(54) METHOD FOR SELLING TICKET BY AUCTION AND SYSTEM THEREOF

(71) Applicant: Aidan Joungil CHO, Austin, TX (US)

(72) Inventor: Aidan Joungil CHO, Austin, TX (US)

(21) Appl. No.: 13/692,159

(22) Filed: Dec. 3, 2012

(30) Foreign Application Priority Data
Dec. 1, 2011 (KR) 10-2011-0127505

(51) Int. Cl. G06Q 30/08; G06Q 10/02

(52) U.S. Cl. CPC G06Q 30/08; G06Q 10/02
USPC 705/5

(57) ABSTRACT

Provided are a system and a method for selling a ticket by auction. The system includes: a bidding price input unit which receives the number of tickets sold in the auction and bidding prices from accessed bidders; an auctioned rank calculator which calculates auctioned ranks estimated when the auction is ended, by using the bidding prices of the bidders and calculating an expected lowest successful bidding price which is a bidding price to be input by the bidder so that the bidder is a successful bidder, by using a total number of tickets sold; and an auctioned price calculator which calculates an auctioned price of each successful bidder of the auction when the auction is ended, wherein if the bidder bids at a price lower than the expected lowest successful bidding price, the bidding price input unit does not accept bidding of the bidder.

### CROSS-REFERENCE TO RELATED PATENT APPLICATION

This application claims the benefit of Korean Patent Application No. 10-2011-0127505, filed on Dec. 1, 2011, in the Korean Intellectual Property Office, the disclosure of which is incorporated herein in its entirety by reference.

### BACKGROUND OF THE INVENTION

1. Field of the Invention

The present invention relates to a method for selling a ticket by an auction and a system thereof, and more particularly, to a method for using an auction to sell a ticket of a performance or the like at an appropriate price between a supplier and a consumer, and a system thereof.

2. Description of the Related Art

If tickets used for entering a performance, film screening, a show a sports stadium, an amusement park, or the like are sold, the tickets are sold on a site or through an Internet reservation.

If tickets is sold on the site or through the Internet reservation as described above, users are to make purchase requests before the tickets are sold out, and thus buyers of the tickets are determined in order of the purchase requests.

If the tickets are not much in demand, the above-described method is not a problem. However, if the tickets are much in demand, selling of the tickets are ended within a very short time. Therefore, many people are never able to try to buy the tickets.

In particular, in this case, the problem is that the tickets are sold at high prices on the black market by ticket touts.

If the tickets are sold at high prices by the ticket touts, buyers buy the tickets at unreasonable high prices and suffer losses. Therefore, these payments do not go back to performers, etc., the ticket touts who have nothing to do with the performances, etc. have most profit.

A method of selling tickets by using an auction has appeared.

Korean Patent Publication No. 2008-1562 (System for Selling Left Tickets and Program Recording Medium Therefor; published on Jan. 3, 2008) which has disclosed such a method by which left tickets are sold by a predetermined bundle of tickets through an auction.

In this method, prices are determined by demands and supplies, but the tickets are not sold one by one but are sold in a bundle way. Therefore, not traders who buy tickets in large quantities but individuals are difficult to participate in buying the tickets.

One of reasons why it is difficult to introduce a general auction method is that a general auction is made in a bundle unit, and all things corresponding to the bundle are auctioned to a successful bidder who suggests the highest bidding price.

In other words, thickets are to be sold one by one but are not sold to each buyer one by one in a general auction method. Therefore, all tickets put up at auction are sold only to a person who suggests the highest bidding price at auction.

### SUMMARY OF THE INVENTION

The present invention provides a method for selling tickets to individual buyers through a modified auction method and a system thereof.

The present invention also provides a computer-readable recording method having recorded thereon a program for realizing the method.

According to an aspect of the present invention, there is provided a method for selling a ticket by auction, including: receiving the number of tickets sold in the auction and bidding prices from accessed bidders; calculating auctioned ranks estimated when the auction is ended, by using the bidding prices of the bidders and calculating an expected lowest successful bidding price which is a bidding price to be input by the bidder so that the bidder is a successful bidder, by using a total number of tickets sold; and calculating an auctioned price of each successful bidder of the auction when the auction is ended, wherein if the bidder bids at a price lower than the expected lowest successful bidding price, bidding of the bidder is not accepted.

According to another aspect of the present invention, there is provided a system for selling a ticket by auction, including: a bidding price input unit which receives the number of tickets sold in the auction and bidding prices from accessed bidders; an auctioned rank calculator which calculates auctioned ranks estimated when the auction is ended, by using the bidding prices of the bidders and calculating an expected lowest successful bidding price which is a bidding price to be input by the bidder so that the bidder is a successful bidder, by using a total number of tickets sold; and an auctioned price calculator which calculates an auctioned price of each successful bidder of the auction when the auction is ended, wherein if the bidder bids at a price lower than the expected lowest successful bidding price, the bidding price input unit does not accept bidding of the bidder.

The bidding price input unit may receive priorities of preferred seats from the bidders. The system may further includes a seat allocator which, if the bidder becomes a successful bidder, preferentially allocates a seat to the bidder according to an auctioned rank and allocates seats based on priorities of preferred seats of the bidders.

The system may further include a donation processor which processes a predetermined sum of money of money corresponding to the auctioned price to be automatically donated to a predetermined donation organization.

The bidding price input unit may receive a bidding range from the bidder and, if the bidding price of the bidder is lower than or equal to a reference price set by the bidder after bidding starts within the bidding range, rebidding within the bidding range so that the bidding price exceeds the reference price.

The auctioned price calculator may calculate the auctioned price so that, if the bidding price is lower than or equal to the reference auctioned price, the bidding price becomes an auctioned price, and if the bidding price is higher than the reference auctioned price, a price discounted from the bidding price becomes the auctioned price at a predetermined rate of a difference between the bidding price and the reference auctioned price.

The reference auctioned price may be a price set by a seller of the tickets or an average price of bidding prices of the successful bidders.

According to another aspect of the present invention, there is provided a non-transitory computer readable recording medium having recorded thereon a program for realizing the method.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a system for selling tickets by auction according to an exemplary embodiment of the present invention; and

FIG. 2 is a flowchart illustrating a method for selling tickets by auction according to an exemplary embodiment of the present invention.

### DETAILED DESCRIPTION OF THE INVENTION

The present invention provides a method for selling tickets by auction and a system thereof.

In more detail, if a person who wants to sell tickets requests auction, the auction is held in a method b which people wanting to buy the tickets access to input the number of necessary tickets and hopeful bidding prices. If the auction is ended, tickets determined in order of bidding prices are distributed to sell all the tickets to the buyers by one time auction.

Also, in the above-described auction process, the buyers may automatically change their bidding prices or contacts with the buyers may be made. Therefore, the buyers do not need to continue watching a bidding situation in order not to fail the auction.

In addition, a winning bid determined by the auction is not simply determined by bidding prices of the buyers, but the buyers receive a predetermined sum of money discount. Therefore, buying price differences between the buyers who have bought the thickets by the auction may be reduced.

Moreover, some of profits obtained by the auction is donated to contribute to profits and public welfare through the auction.

Exemplary embodiments of the present invention will now be described in detail with reference to the attached drawings.

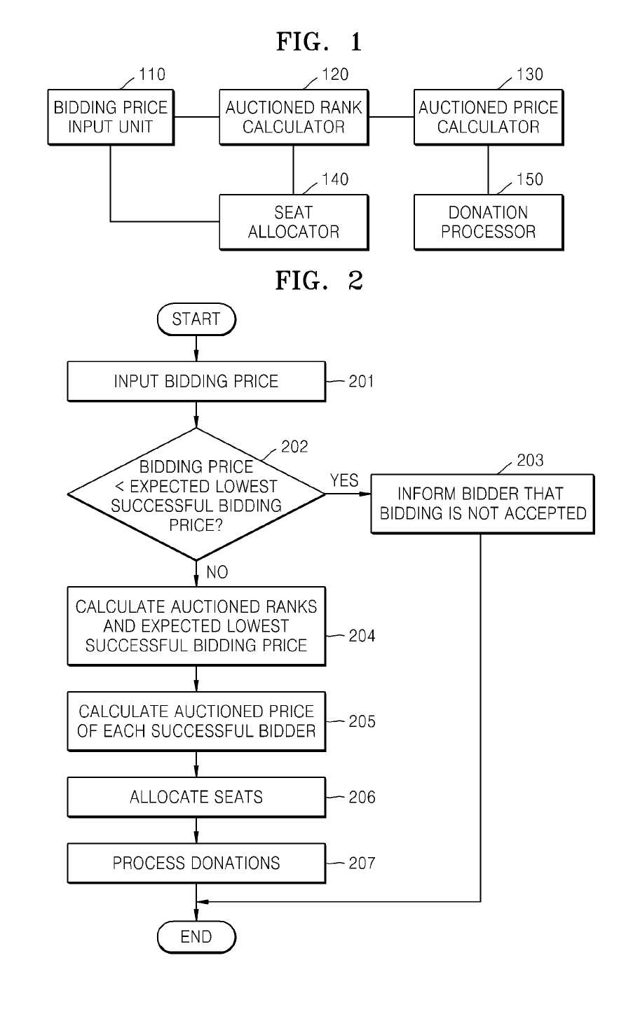

FIG. 1 is a block diagram illustrating a structure of a system for selling tickets by auction according to an exemplary embodiment of the present invention.

Referring to FIG. 1, the system includes a bidding price input unit 110, an auctioned rank calculator 120, an auctioned price calculator 130, a seat allocator 140, and a donation processor 150.

The bidding price input unit 110 provides accessed users with information about tickets of ticket sellers who have requested auction and receive buying quantities, bidding prices etc. from the accessed users.

The information provided to the accessed users basically includes a type of the tickets, a selling period and may further include information about seats, the expected lowest successful bidding price, etc.

The biding price input unit 110 receives selections of tickets to be bought, the number of selected tickets, and bidding prices from the users.

Here, the bidding price input unit 110 may inform a user of an expected lowest successful bidding price at which the user may currently bid and if a bidding price of the user is lower than the expected lowest successful bidding price, inform the user of the fact not to accept the bid of the user.

A method of determining the expected lowest successful bidding price will be described later along with the auctioned rank calculator 120 which will be described later.

The bidding price input unit 110 may inform the user of the expected lowest successful bidding price in real time. However, if it is impossible to inform users of the expected lowest successful bidding price due to simultaneous inputs of lots of bids, the bidding price input unit 110 may inform the users of the expected lowest successful bidding price on a regular cycle with leaving intervals of several seconds.

The bidding price input unit 110 may receive an e-mail address, a phone number, or the like of the user and, if the bidding price of the user is lower than the expected lowest successful bidding price at auction, may inform the user of this through an e-mail, a text message, an advanced record system (ARS), or the like.

The bidding price input unit 110 may accept one fixed price when receiving biding prices but may receive the bidding prices according to a method by which a bidding range and a bidding method are designated.

In this case, if the bidding prices are lower than or equal to a preset reference price, the bidding price input unit 110 automatically makes a bid again within the bidding range so that the bidding prices exceed the preset reference price.

Here, designating the bidding range means that a first bidding price and a highest bidding price allowed by a bidder are designated.

Designating the bidding method means that bidding starts in which method within the bidding range, i.e., includes a re-bid reference price and a price calculating method in the re-bid.

Here, the reference price may be determined based on the expected lowest successful bidding price, and the re-bid reference price may be determined based on the expected lowest successful bidding price.

For example, if the reference price is determined as a price immediately below the expected lowest successful bidding price, and a bidding price is lower than the expected lowest successful bidding price, bidding may automatically re-start at the expected lowest successful bidding price.

However, if there are many people who have set these or there are many people who want to bid at the expected lowest successful bidding price, their bidding prices may become lower than the expected lowest successful bidding price when the auction is ended and thus, they may fail to buy desired tickets. Therefore, a bidding price may be set to be higher than the expected lowest successful bidding price by a predetermined sum.

For example, if a current expected lowest successful bidding price is 10,000, a buyer thinks that the buyer can afford 50,000 to the utmost limit to buy a ticket, an initial bidding price may be set to 10,000, and a highest bidding price may be set to 50,000 to set a bidding range. Also, the bidding range may be set to allow the buyer tray re-bidding at a price 5,000 higher than the expected lowest successful bidding price when a rank of the buyer falls below a biddable rank.

Here, if bidding may be set to be cancelled during auction, first bidding may be cancelled.

Also, although the bidding price of the user is not lower than the expected lowest successful bidding price, if the expected lowest successful bidding price is received within a set price difference, the buyer may automatically cancel previous bidding and try new bidding.

If the current expected lowest successful bidding price is 10,000 in the previous example, bidding is opened at 11,000. If the lowest biding price is 10,500, the bidding of 11,000 is automatically cancelled, and re-bidding is opened at 11,500.

If a bidding method is set as described above the buyer may buy a desired ticket through a one-time bidding process as long as the expected lowest successful bidding price does not rise to a price higher than a level that the buyer can afford. Also, the buyer does not need to participate in the bid at a high biding price.

The bidding price input unit 110 may receive the following details besides the bidding price.

The bidding price input unit 110 may receive information about preferred seats.

If seats are designated on tickets as in a performance hall, a theater, or the like, the bidding price input unit 110 may receive the information about the seats.

Although prices of tickets are the same, people may prefer different seat positions. In other words, although people buy the same R seat, there may be people who prefer seats closer to a stage or people who prefer middle seats of the R seat.

Since people may prefer different seats, the bidding price input unit 110 receives information about this when accepting bids, to reflect this on seat allocations when buyers are auctioned and thus buy thickets.

When the bidding price input unit 110 receives information about preferred seats, the preferred seats may be prioritized like a first priority, a second priority, etc., to select a plurality of seats. Here, one seat may match with one priority or one group of seats in which several seats are bundled may match with one priority.

The bidding price input unit 110 may receive information about donations.

In the present invention, a predetermined sum of sales may be automatically donated to predetermined donation organizations. Therefore, buyers' buying of tickets contributes public interests, and repulsions which may occur if buyers buy tickets at high prices may be lowered.

When the bidding price input unit 110 receives information about the donations, the bidding price input unit 110 may also receive information about donation places.

The information about the donation places may be directly input by the buyers or may be pre-listed by a system operator, or one of the donation places may be selected.

If the buyer designates a donation organization, the system operator or the like is requires to check whether the donation organization is a just donation organization, i.e., a complicated procedure is required. Therefore, a list of donation organizations selectable by the buy may be designated by the system operator, and the buyer may select a donation organization from the list.

The auctioned rank calculator 120 calculates estimated auctioned ranks by using bidding prices of bidders when the auction is ended and calculates an expected lowest successful bidding price to be input by a bidder so that the bidder is a successful bidder, by using a total number of tickets sold

In general, auctioned ranks refer to ranks definitely determined when the auction is ended. However, in the present invention, auctioned ranks determined by the auctioned rank calculator 120 include auctioned ranks which are estimated based on the bidding prices of the bidders so far even before the auction is ended.

Here, the auctioned rank calculator 120 calculates the expected lowest successful bidding price by using the calculated auctioned ranks.

The expected lowest successful bidding price is a price bid by a lowest rank successful bidder estimated when ranks are calculated.

If the number of tickets does not proceed, a minimum bidding price determined by the seller or the system operator becomes the expected lowest successful bidding price and an auction starting price.

If the number of tickets requested by the bidders to buy is greater than or equal to a total number of sold tickets, the expected lowest successful bidding price is determined according to the auctioned ranks.

For example, if there are 100 tickets, a 100^{th} highest bidding price (which is a rank based on the number of tickets) is an expected lowest successful bidding price.

The expected lowest successful bidding price determined as described above is provided to the bidding price input unit 110 to be used to output a warning message to the buyers who input bidding prices lower than the expected lowest successful bidding price or to be used not to be bid.

If the auction is ended, the auctioned price calculator 130 calculates a final auctioned price according to successful bidders.

There may be several methods of calculating an auctioned price.

An auctioned price may be determined based on bidding prices bid by bidders.

In other words, a bidder who bids a high price pays the high price to buy a ticket, and a bidder who bids a low price pays the low price to buy a ticket.

In this case, price differences may occur among the successful bidders, and a bidder who has estimated a high auctioned price and has bid high may have complaints.

In order to solve this problem, if the auctioned price is higher or equal to a predetermined reference auctioned price, a bidder may buy a ticket at a price discounted more than an actual bidding price. If the auctioned price is lower than or equal to the predetermined auctioned reference price, the bidder may buy the ticket at a price bid by the bidder.

Here, the reference auctioned price may be a predetermined price or a price determined according to bidding prices of successful bidders.

The predetermined reference auctioned price will be first described.

A seller may set an appropriate ticket price considered by the seller before the seller sells tickets to the reference auctioned price.

As a final auction result, a successful bidder who has bid higher than the reference auctioned price determined by the seller may receive a predetermined price discount from a bidding price of the successful bidder to buy a ticket.

Here, the discounted price may be a predetermined price or a price determined at a rate based on a bidding price like 10%.

Also, a predetermined rate of a difference between the bidding price of the successful bidder and the reference auctioned price may be determined as the discounted price. In other words, only a successful bidder who has bids a bidding price higher than the reference auctioned price may receive a discount at a predetermined rate to buy a ticket.

If a discount rate is 100%, a successful bidder who has bid a bidding price higher than the reference auctioned price may buy a ticket at the reference auctioned price.

The reference auctioned price may be changed based on bidding prices of successful bidders. This will now be described.

In this case, the reference auctioned price is determined by the bidding prices of the successful bidders which have been statistically processed.

For example, an average of the bidding price of the successful bidders may be determined as the reference auctioned price.

The reason why the reference auctioned price is determined not based on all bidders but based on the successful bidders is that, if bidding prices of the all bidders are used, variations in the bidding prices are wide, and thus meaningful values are obtained.

A method by which successful bidders who has bid biding prices higher than the reference auctioned price after the reference auctioned price is determined is equal to the method by which the reference auctioned price is determined at a fixed price.

The seat allocator 140 allocates seats to successful bidders.

In general, if reservations are made on-line, the reservations are made and seats are selected on-line. Alternatively, after the reservations are made, seats are allocated in a real performance hall. Therefore, the seats are allocated in order of reservations. However, if auctioned prices of successful bidders are different on seats having the same rank, priorities may be given to allocations of seats according to auctioned prices paid by the successful bidders.

The seat allocator 140 allocates seats to successful bidders according to information which is on preferred seats input by the successful bidders and is input from the bidding price input unit 110 and the auctioned ranks calculated by the auctioned rank calculator 120.

In other words, the seat allocator 140 preferentially allocates seats preferred by successful bidders having high auctioned ranks and allocates successful bidders having low auctioned ranks seats left after being allocated to successful bidders having higher ranks.

Each successful bidder may input a preferred seat according to priorities of a first rank, a second rank, etc. and thus may be allocated a first priority seat among preferred seats of left seats which are prioritized by the successful bidder.

If there is not a preferred seat of a successful bidder among the left seats, a seat may be allocated by lot among the left seats.

Also, if the system operator or a ticket seller presets priorities of seats according to ranks, a seat of the left seats having the highest priority may be allocated to a successful bidder who has an order of being allocated a seat whose set preferred seat has been allocated to another bidder.

The donation processor 150 donates some of ticket sales to a preset donation organization.

Donation organizations may be pre-designated by bidders when bidding starts through the bidding price input unit 110.

Here, as described above, the bidders may directly input the donation organizations or the system operator or the ticket seller may register connected donation organizations so that the bidders select one of the connected donation organizations.

If the system operator registers the donation organizations, the system operator may make contracts with the donation organizations to deputize issues of donation receipts. Therefore, the donation organizations to which donations have been made may automatically issue donation receipts.

In order to issue donation receipts, information about donators may be provided to the donation organizations, and donation receipts may be issued by using information of the donators provided from the donation organizations and then delivered to the donators. However, the donation receipts may be automatically issued in the system of the present invention to provide conveniences to donatories and donators.

Also, if donation receipts are issued by an intermediary as described above, buyers who have accessed the system of the present invention to become members in order buy tickets may be issued donation receipts by using information input by the buyers when becoming the members. Therefore, the buyers do not need to input additional information for issuing donation receipts when starting bidding and may be satisfied with that buyers' information is used only in organizations (systems) into which the buyers input the information and is not provided to other organizations.

The process of the donation processor 150 for processing donations and issuing donation receipts will now be described.

If the auction is ended, and depositing of ticket buying payments is checked, the donation processor 150 and transmits a predetermined sum to a donation organization which is set through the bidding price input unit 110 by a buyer or is preset by the system operator or the ticket seller.

There may be several methods of transmitting a donation to a donation organization. The most general method is to register an account number of a donation organization so that donations are automatically deposited into the account number.

All of donations incurring based on all sold tickets may be delivered at a time or an additional virtual account number may be generated according to each successful bidder to deliver a donation of each successful bidder through the additional virtual account number.

Although donations of all successful bidders are delivered at a time, information about a donation of each of the successful bidders may be additionally recorded to be used in order to issue donation receipts to the successful bidders.

When the donation receipts are issued, information about basic information about the successful bidders and donations may be included in a predetermined donation receipt form and then output to be sent by mail. Alternatively, the information may be sent to the successful bidders through methods allowed by law such as an e-mail, and breakdowns thereof may be electronically reported to a system of Nations Tax Service (NTS) or the like.

Donations may be determined by several methods.

A predetermined rate may be determined as a donation based on ticket sales, i.e., an auctioned price. For example, 1% of the auctioned price may be determined as a donation.

As another method, a predetermined sum may be constantly determined as a donation regardless of an auctioned price. For example, 1,000 won may be constantly determined as a donation regardless of the auctioned price.

As another method, a difference between an auctioned price and a reference auctioned price or a predetermined rate of the difference may be determined as a donation based on the reference auctioned price.

For example, if the reference auctioned price 10,000 won, and the auctioned price is 15,000 won, 5,000 won may be determined as a donation or a predetermined rate (e.g., 10%) of 5,000 won may be determined as a donation.

In this case, if the auctioned price is lower than the reference auctioned price, all payments of successful bidders go to the ticket seller and thus, the ticket seller is not damaged. If the auctioned price is higher than the reference auctioned price, a sum of money except donations may be provided to the ticket seller, and thus the ticket seller may secure a profit corresponding to the reference auctioned price.

FIG. 2 is a flowchart illustrating a method for selling a ticket by auction according to an exemplary embodiment of the present invention.

Information about the number of tickets to be sold, a lowest selling price (an auction starting price), a reference auctioned price, etc. is received from a seller. Next, if the auction starts at an auction starting date to accept bidding from accessed buyers.

In operation 201, the bidding price input unit 110 shows accessed buyers thickets of ticket sellers who have request auctions and accept auctions from the buyers.

As described above, information provided to the buyers basically includes kinds of tickets and selling periods and may further include information about seats, an expected lowest successful bidding price, etc.

In operation 202, the bidding price input unit 110 receives selects of tickets to be bought, the number of selected tickets, and prices to be bid from the buyers, and determines whether bidding prices of the buyers are lower than the expected lowest successful bidding price.

If the bidding prices is lower than the expected lowest successful bidding price, the bidding price input unit 110 outputs this fact onto screens of the buyers in operation 203 and ends a bidding process so that the bidding prices lower than the expected lowest successful bidding price are auctioned.

When receiving the bidding, the bidding price input unit 110 provides the buyers with the expected lowest successful bidding price which is currently biddable to induce the buyers to bid prices higher than or equal to the expected lowest successful bidding price. If the buyers trying bidding at bidding prices lower than the expected lowest successful bidding price, the bidding price input unit 110 outputs this fact on screens and ends the bidding process as described above.

Here, the expected lowest successful bidding price may be a lowest selling price determined by a seller and then may be price determined by the auctioned rank calculator 120 based on an auctioned price.

The bidding price input unit 110 receives an e-mail address or a phone number and, if a bidding price of a buyer becomes lower than the expected lowest successful bidding price during auction, informs the buyer of this through an e-mail, a text message, an ARS, or the like.

The bidding price input unit 110 may receive one fixed price but may receive a bidding price according to a method of designating a bidding range and a bidding method. The designating of the bidding range means that an initial bidding price and a highest bidding price allowable by a bidder are designated. The designating of the bidding method means that bidding proceeds in which way within the designated bidding range includes a reference price for re-bidding and a price calculating method in re-bidding as described above.

Also, as described above, the reference price may be an expected lowest successful bidding price, and a bidding price for re-bidding may be calculated based on the expected lowest successful bidding price.

The bidding price input unit 110 may receive information about preferred seats besides bidding prices. When the bidding price input unit 110 receives the information about the preferred seats, the bidding price input unit 110 may give several priorities like a first priority, a second priority, etc. to select a plurality of seats. The bidding price input unit 110 may match one priority with one seat or may give priorities to a group of several seats as described above.

The bidding price input unit 110 may receive information donations. Bidders may directly input donation organizations, etc., and a system operator or a ticket seller may determine a list of donation organizations. Also, the bidders may select one donation organizations from the list as described above.

If the bidders start bidding, the auctioned rank calculator 120 calculates ranks of the bidders who participate in auction and an expected lowest successful bidding price in operation 204.

Here, the auctioned ranks refer to auctioned ranks estimated when auction proceeds and refer to auctioned ranks determined after the auction is ended as described above.

In operation S205, the auctioned price calculator 130 calculates a final auctioned price according to successful bidders when the auction is end.

According to a method of calculating the auctioned price, the auctioned price may be determined based on a bidding price of a bidder. However, if the auctioned price is higher than a predetermined reference auctioned price, the bidder may buy a ticket at a price discounted off the bidding price. If the auctioned price is lower than or equal to the predetermined reference auctioned price, the bidder may buy the ticket at the bidding price of the bidder as described above.

Here, the reference auctioned price may be a predetermined price and may be a price determined according to bidding prices of successful bidders as described above.

If the reference auctioned price is a predetermined price, a ticket seller may determine an appropriate ticket price considered by the ticket seller to set the appropriate ticket price to the reference auctioned price.

The method of determining the reference auctioned price according to the bidding prices of the successful refers to a method of determining the reference auctioned price according to the bidding prices of the successful bidders which have been statistically processed. As a representative example, an average of bidding prices of successful bidders may be determined as the reference auctioned price.

As a final auction result, a successful bidder who has bid higher than the reference auctioned price determined by the ticket seller receives a predetermined discount from a bidding price of the successful bidder to buy a ticket. Here, as described above, the discounted sum may be a predetermined sum of money, a sum of money determined at a rate based on a bidding price like 10%, a difference between a bidding price of a successful bidder and a reference auctioned price, or a sum of money discounted at a predetermined rate from the difference.

In operation, the seat allocator 140 allocates seats to successful bidders.

The seat allocator 140 allocates the seats to the successful bidders according to information about preferred seats input by the successful bidders and auctioned ranks calculated by the auctioned rank calculator 120 to preferentially allocate preferred seats to successful bidders having high auctioned ranks.

If there preferred seats input by successful bidders to be allocate seats among left seats, the seat allocator 140 may allocate seats from the left seats by lot. The seat allocator 140 may allocate a seat having the highest priority from the left seats to a successful bidder which is to be allocated a seat according to priorities of seats of ranks preset by the system operator or the ticket seller as described above.

In operation S207, the donation processor 150 processes some of ticket sales to be donated to preset donation organizations.

As described above, bidders may directly designate donation organizations or the system operator or the ticket seller may register connected donation organizations to allow bidders to select one of the connected donation organizations.

If the auction is ended, and purchase payments of tickets are deposited, the donation processor 150 delivers a predetermined sum of money to a donation organization which is set by a bidder through the bidding price input unit 110 or is preset by the system operator or the ticket seller. Also, the donation processor 150 delivers a donation receipt to a successful bidder, who has made a donation, according to a predetermined donation receipt form or a method allowed by law such as an e-mail or the like.

As a method of transmitting a donation to a donation organization, a method of registering an account number of a donation organization and setting the donation to be automatically deposited into the account number may be a representative method but is not limited thereto.

As described above, all of donations incurring based on a total of sold tickets may be delivered at a time, or virtual account numbers may be generated according to successful bidders one by one to deliver donations through the virtual account numbers according to the successful bidders.

A procedure performed after the auction is ended is not a characteristic part of the present invention and thus is not additionally described. However, the procedure may be performed from a common sense, and a structure thereof is not limited.

For example, if a buyer who has bought a ticket by auction wants to refund a payment, a refund procedure may be performed according to the same method as a general refund procedure.

Also, a payment method and a ticket deliver method, which are used in a ticket buying method through an e-commerce or the Internet, may be generally used as a ticket payment method from successful bidders who have been auctioned and a ticket delivering method.

If all of tickets to be sold are not sold by auction, a procedure for processing left tickets is not limited.

For example, there may be used a method of re-selling unsold tickets at a single price or a method of lowering a first auction price to re-start auction.

As described above, according to the present invention, all tickets are sold by one-time auction. However, the all tickets are not sold to one bidder who has bids a highest bidding price but may be independently sold to buyers one by one.

Also, a bidding method is conveniently used to help buyers conveniently participating in auction.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and so on.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A system for selling a ticket by auction, comprising:
a bidding price input unit which receives the number of tickets sold in the auction and bidding prices from accessed bidders;
an auctioned rank calculator which calculates auctioned ranks estimated when the auction is ended, by using the bidding prices of the bidders and calculating an expected lowest successful bidding price which is a bidding price to be input by the bidder so that the bidder is a successful bidder, by using a total number of tickets sold; and
an auctioned price calculator which calculates an auctioned price of each successful bidder of the auction when the auction is ended,
wherein if the bidder bids at a price lower than expected lowest successful bidding price, the bidding price input unit does not accept bidding of the bidder.

2. The system of claim 1, wherein the bidding price input unit receives priorities of preferred seats from the bidders,
wherein the system further includes: a seat allocator which, if the bidder becomes a successful bidder, preferentially allocates a seat to the bidder according to an auctioned rank and allocates seats based on priorities of preferred seats of the bidders.

3. The system of claim 1, further comprising:
a donation processor which processes a predetermined sum of money of money corresponding to the auctioned price to be automatically donated to a predetermined donation organization.

4. The system of claim 1, wherein the bidding price input unit receives a bidding range from the bidder and, if the bidding price of the bidder is lower than or equal to a reference price set by the bidder after bidding starts within the bidding range, rebidding within the bidding range so that the bidding price of the bidder exceeds the reference price.

5. The system of claim 1, wherein the auctioned price calculator calculates the auctioned price so that, if the bidding price is lower than or equal to the reference auctioned price, the bidding price becomes an auctioned price, and if the bidding price is higher than the reference auctioned price, a price discounted from the bidding price becomes the auctioned price at a predetermined rate of a difference between the bidding price and the reference auctioned price.

6. The system of claim 5, wherein the reference auctioned price is a price set by a seller of the tickets.

7. The system of claim 5, wherein the reference auctioned price is an average price of bidding prices of the successful bidders.

8. A method for selling a ticket by auction, comprising:
receiving the number of tickets sold in the auction and bidding prices from accessed bidders;
calculating auctioned ranks estimated when the auction is ended, by using the bidding prices of the bidders and calculating an expected lowest successful bidding price which is a bidding price to be input by the bidder so that the bidder is a successful bidder, by using a total number of tickets sold; and
calculating an auctioned price of each successful bidder of the auction when the auction is ended,
wherein if the bidder bids at a price lower than the expected lowest successful bidding price, bidding of the bidder is not accepted.

9. The method of claim 8, further comprising:
receiving priorities of preferred seats from the bidders,
if the bidder becomes a successful bidder, preferentially allocating a seat to the bidder according to an auctioned rank and allocating seats based on priorities of preferred seats of the bidders.

10. The method of claim 8, further comprising:
processing a predetermined sum of money of money corresponding to the auctioned price to be automatically donated to a predetermined donation organization.

11. The method of claim 8, wherein the receiving of the bidding price comprises:
receiving a bidding range from the bidder: and
if the bidding price of the bidder is lower than or equal to a reference price set by the bidder after bidding starts within the bidding range, rebidding within the bidding range so that the bidding price exceeds the reference price.

12. The method of claim 8, wherein the auctioned price is calculated so that, if the bidding price is lower than or equal to a predetermined reference auctioned price, the bidding price becomes an auctioned price, and if the bidding price is higher than the reference auctioned price, a price discounted from the bidding price becomes the auctioned price at a predetermined rate of a difference between the bidding price and the reference auctioned price.

13. The method of claim 12, wherein the reference auctioned price is a price set by a seller of the tickets.

14. The method of claim 12, wherein the reference auctioned price is an average price of bidding prices of the successful bidders.

15. A non-transitory computer readable recording medium having recorded thereon a program for realizing the method of claim 8.
